(19) United States
(12) Patent Application Publication
(10) Pub. No.: US 2003/0024975 A1
(43) Pub. Date: Feb. 6, 2003

(54) System and method for authoring and providing information relevant to the physical world

(76) Inventor: Ajit V. Rajasekharan, East Brunswick, NJ (US)

Correspondence Address: BROBECK, PHLEGER & HARRISON, LLP, ATTN: INTELLECTUAL PROPERTY DEPARTMENT, 1333 H STREET, N.W. SUITE 800, WASHINGTON, DC, 20005, US

(21) Appl. No.: 09/987,597

(22) Filed: Nov. 15, 2001

Related U.S. Application Data
(60) Provisional application No. 60/306,356, filed on Jul. 18, 2001.

(51) Int. Cl. G06F 17/00

(52) U.S. Cl. 235/375

(57) ABSTRACT

A system and method capable of reading machine-readable labels from physical objects, reading coordinate labels of geographical locations, reading timestamp labels from an internal clock, accepting digital text string labels as input obtained directly from a keyboard type input device, or indirectly using a speech-to-text engine transforming any other label type information encoding into digital data by some transduction means, and treating these different labels uniformly as object identifiers for performing various indexing operations such as content authoring, playback, annotation and feedback. The system further allows for the aggregating of object identifiers and their associated content into a single addressable unit called a tour. The system can function in an authoring and a playback mode. The authoring mode permits new audio/text/graphics/video messages to be recorded and bound to an object identifier. The playback mode triggers playback of the recorded messages when the object identifier accessed. In the authoring mode, the system supports content authoring that can be done coincident with object identifier creation thereby enabling authored content to be unambiguously bound to the object identifier. In the playback mode, the system can be programmed to accept/solicit annotations/feedback from a user which may also be recorded and unambiguously bound to the object identifier.

### RELATED APPLICATION

The present invention claims priority to U.S. Provisional Patent Application No. 60/306,356 filed on Jul. 18, 2001.

### BACKGROUND OF THE INVENTION

1. Field of Invention

This invention relates generally to information systems and, particularly, to a system and method for authoring and providing information relevant to a physical world.

2. Description of the Related Art

The exponential growth of the Internet has been driven by three factors, namely, the ability to author content easily for this new medium, the simple text-string, e.g., uniform-resource locator (“URL”), based indexing scheme for content organization, and the ease of accessing authored content, e.g., by just a mouse click on a hyperlink. However, attempts made to emulate the success of the Internet in the mobile device usage space have not been very successful to date. The mobile device usage space is the whole physical world we live in and, unlike the tethered personal computer (“PC”) based Internet world where all objects are virtual, the physical world is composed of real objects, geographical locations, and temporal events, which occur in isolation or in conjunction with an object or location. These diversities pose problems not present in the existing Internet world where all virtual objects can be uniformly addressed by a URL.

Attempts have been made to build applications that enable seamless browsing of just one domain, such as the domain of physical objects or the domain of geographical locations. There have also been attempts to treat browsing of objects and locations together. However, these attempts fail to address the key factors mentioned above that made the Internet what it is today, i.e., the most effective medium for information dissemination. In particular, these attempts do not effectively address the labeling issue, i.e., interpreting information of different formats across different labeling schemes. This is a problem unique to the physical world and not present in the PC-based virtual browsing method where all content in the virtual world can be addressed by a URL. Moreover, they do not support authoring of content that is bound to these different label types, content authoring on the device (which is a key deficiency given that on-device content authoring is the most natural, efficient, and error-free method for most mobile device usage scenarios), nor playback of content indexed by the different labeling schemes.

To enable seamless mobile browsing which envelops all of these apparently disparate application domains these deficiencies need to be addressed. The absence of a labeling and content binding scheme makes it very hard for one to do custom labeling of objects and bind content to the labels. The absence of an annotation/feedback binding scheme makes it very hard to maintain the correspondence between the content and the annotation/feedback. The absence of seamless bridging of location-based, object-based, events-based, and conventional web hyperlink based services requires different devices/applications to navigate these different domains.

There are four separate application domains in the mobile device space, namely, object-based devices and applications, coordinate-based devices and applications, temporal based devices and applications, and traditional URL-based devices and applications. Object-based devices can read labels off of physical objects via barcodes, radio-frequency identification (“RFID”), or infra-red (“IR”) tags, and are typically used in a proactive fashion where a user scans the object of interest using the devices. These devices attempt to support browsing the world of physical objects in a manner that is similar to surfing the Internet using a web browser. The coordinate-based application domain is an emerging domain capitalizing on the knowledge of geographical locations made available through a variety of location detection schemes based on a global-positioning system (“GPS”), an assisted-GPS (“A-GPS”) where satellite signals may be weak, an angle of arrival (“AOA”) system, or a time difference of arrival (“TDOA”) system. An existing application domain in the PC-world, e.g., timeline based information presentation, is also making inroads into the mobile device space. However, no devices or applications presently exist that are capable of bridging these different application domains in a near seamless and transparent manner.

In the field of portable interactive digital information systems that employ device-readable object or location identifiers several systems are known. For example, U.S. Pat. No. 6,122,520 describes a location information system which uses a positioning system, such as the Navstar Global positioning system, in combination with a distributed network. The system receives a coordinate entry from the GPS device and the coordinate is transmitted to the distributed network for retrieval of the corresponding location specific information. Barcodes, labels, infrared beacons and other labeling systems may also be used in addition to the GPS system to supply location identification information. This system does not, however, address key issues characteristic of the physical world such as custom labeling, label type normalization, and uniform label indexing. Furthermore, this system does not contemplate a tour like paradigm, i.e., a “tour” as media content grouped into a logical aggregate.

U.S. Pat. No. 5,938,721 describes a task description database accessible to a mobile computer system where the tasks are indexed by a location coordinate. This system has a notion of coordinate-based labeling, coordinate-based content authoring, and coordinate triggered content playback. The drawback of the system is that it imposes constraints on the capabilities of the device used to playback the content. Accordingly, the system is deficient in that it fails to permit content to be authored and bound to multiple label types or support the notion of a tour.

U.S. Pat. No. 6,169,498 describes a system where location-specific messages are stored in a portable device. Each message has a corresponding device-readable identifier at a particular geographic location inside a facility. The advantage of this system is that the user gets random access to location specific information. The disadvantage of the system is that it does not provide information in greater granularity about individual objects at a location. The smallest unit is a ‘site’ (a specific area of a facility). Another disadvantage of the system is that the user of the portable device is passive and can only select among pre-existing identifier codes and messages. The user cannot actively create identifiers nor can he/she create or annotate associated messages. The system also fails to address the need for organizing objects into meaningful collections. Yet another disadvantage is that the system is targeted for use within indoor facilities and does not address outdoor locations.

U.S. Pat. No. 5,796,351 describes a system for providing information about exhibition objects. The system employs wireless terminals that read identification codes from target exhibition objects. The identification codes are used, in turn, to search information about the object in a data base system. The information on the object is displayed on a portable wireless terminal to the user. Although the described system does use unique identification code assigned to objects and a wireless local area network, the resulting system is a closed system: all devices, objects, portable terminals, host computers, and the information content are controlled by the facility and operational only inside the boundaries of the facility.

U.S. Pat. No. 6,089,943 describes a soft toy carrying a barcode scanner for scanning a number of barcodes each individually associated with a visual message in a book. A decoder and audio apparatus in the toy generate an audio message corresponding to the visual message in the book associated with the scanned barcode. One of the biggest drawbacks of this system is the inability to author content on the apparatus itself. This makes it cumbersome for one who creates content to author it for the apparatus, i.e., one has to resort to a separate means for authoring content. It also makes it harder to maintain and keep track of the association with the authored content, object identifiers, and the physical object.

U.S. Pat. No. 5,480,306 describes a language learning apparatus and method utilizing an optical identifier as an input medium. The system requires an off-the-shelf scanner to be used in conjunction with an optical code interpreter and playback apparatus. It also requires one to choose a specific barcode and define an assignment between words and sentences to individual values of the chosen code. The disadvantages of this system are the requirement for two separate apparatus making it quite unwieldy for several usage scenarios and the cumbersome assignment that needs to be done between digital codes and alphabets and words.

U.S. Pat. No. 5,314,336 describes a toy and method providing audio output representative of a message optically sensed by the toy. This apparatus suffers from the same drawbacks as some of the above-noted patents, in particular, the content authoring deficiency.

U.S. Pat. No. 4,375,058 describes an apparatus for reading a printed code and for converting this code into an audio signal. The key drawback of this system is that it does not support playback of recorded audio. It also suffers from the same drawbacks as some of the above-noted patents.

U.S. Pat. No. 6,091,816 describes a method and apparatus for indicating the time and location at which audio signals are received by a user-carried audio-only recording apparatus by using GPS to determine the position at which a particular recording is made. The intent of this system is to use the position purely as a means to know where the recording was done as opposed to using the binding for subsequent playback on the apparatus or for feedback or annotation binding. Also, the timestamp usage in the system fails to contemplate using a timestamp as a trigger for playback of special temporal events or binding a timestamp to objects, coordinates, and labels.

In addition to the patents listed above, which are all incorporated herein in their entirety by reference, there are other systems on the market whose common objective is to link printed physical world information to a virtual Internet URL. More specifically, these systems encode URLs into proprietary barcodes. The user scans the barcode in a catalog and her web browser is launched to the given URL. The advantage of these systems is that they link the physical world to the rich information source of the Internet. The disadvantages of these systems are that the URL is directly encoded in the barcode and cannot be modified and there is a one-to-one mapping between a physical object and digital URL information.

Another conventional system uses standard universal product code (“UPC”) barcode scanning for product lookup and price comparison on the Internet. The advantage of this system is that it does not require a proprietary scanner device and there is an indirection when mapping code to information instead of hard-coded, direct URL links. Nevertheless, all of the above systems disadvantageously treat each object, i.e., each barcode, as an individual item and do not provide a means to create logical relationships among the plurality of physical objects at the same location. Another disadvantage of these systems is that they do not enable the user to create a personalized version of the information or to give feedback.

### SUMMARY OF THE INVENTION

Therefore, a need has arisen for a scheme that addresses the labeling of objects, locations and temporal events, a scheme that has an indexing method which treats these different labels uniformly and transparently to the underlying labeling method, a scheme that can help author content seamlessly for these different physical world entities and bind the content to the indices, and a scheme that can provide easy access and playback of the authored content for any real-world entity, e.g., a physical object, location, and/or temporal event.

To address this need and overcome the deficiencies described in the related art, the inventive concept is embodied in a method for authoring and providing information relevant to a physical world, and an apparatus and system employing such a method. Preferably, a hand-held device that is capable of reading one or more labels such as, but not limited to, a barcode, a RFID tag, IR tag, location coordinates, and timestamp, and for authoring and playing back media content relevant to the labels is utilized. In the authoring mode, labels representing objects, locations, temporal events, and text strings are identified and translated into object identifiers which are then bound to media content that the author records for that object identifier. Media content can be grouped into a logical aggregate called a tour. A tour can be thought of as an aggregation of multimedia digital content, indexed by object identifiers. In the playback mode, the authored content is played when one of the above mentioned labels (barcode, RFID tag, location coordinates, etc.) is read and whose generated object identifier matches one of the identifiers stored earlier in a tour. The system also enables audio, text, graphics, and video annotation to be recorded and bound to the accessed object identifier. Binding to the accessed object identifier is also done for any audio, text, graphics, or video feedback provided by the user on the object.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system used for tour authoring, storage, retrieval, and playback;

FIG. 2 illustrates application domains of various label types as a function of the size of the object being labeled and the detection range of the label;

FIG. 3a illustrates an exemplary tree structure for an instance of a tour;

FIG. 3b illustrates exemplary file formats supported by a tour;

FIG. 4 illustrates examples of bindings that may occur during the labeling, authoring, playback, annotation, and feedback stages of a tour;

FIG. 5a illustrates various label input schemes, label encoding, label normalization process and their implementation within a tour;

FIG. 5b illustrates various proactive label detection schemes and implicit system driven label detection scheme;

FIG. 6 illustrates a process-oriented view of a tour including pre-tour and post-tour processing;

FIG. 7 illustrates an exemplary method used for pre-tour authoring;

FIG. 8 illustrates an exemplary method used for tour playback;

FIG. 9 illustrates an exemplary method for tour playback specifically using a networked remote server site;

FIG. 10 illustrates a block diagram of exemplary internal components of a hand-held mobile device for use within the network illustrated in FIG. 2;

FIG. 11 illustrates an exemplary physical embodiment of a hand-held mobile device; and

FIG. 12 illustrates a further exemplary embodiment of a hand-held mobile device.

### DETAILED DESCRIPTION OF PREFERRED EMBODIMENTS

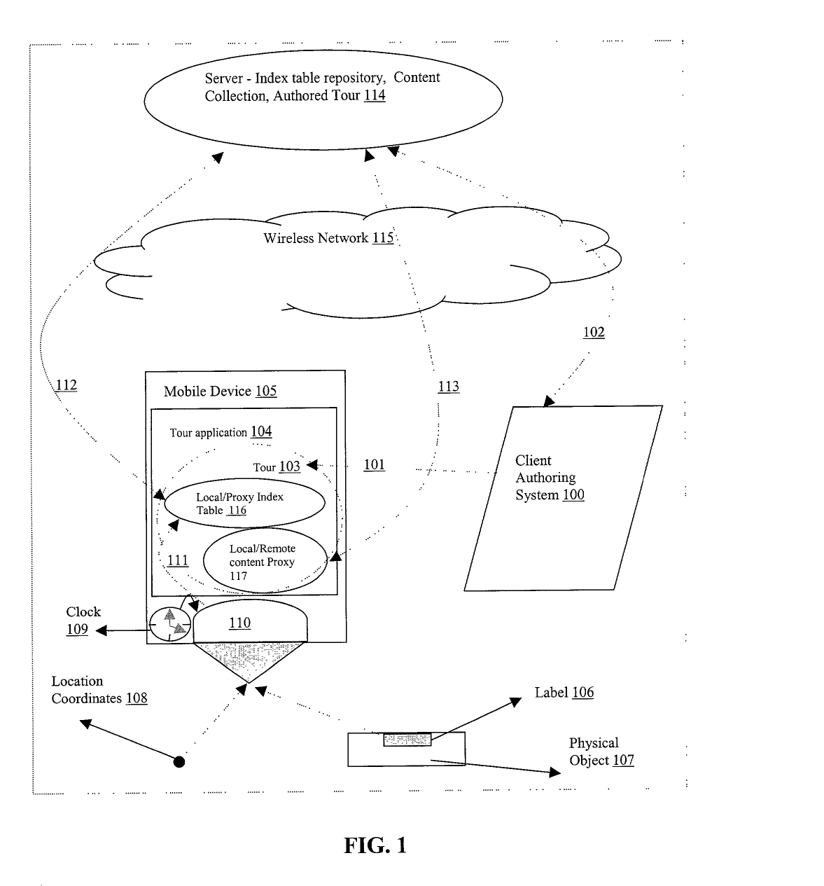

Preferred embodiments of the present invention and their advantages may be understood by referring to FIGS. 1-12, wherein like reference numerals refer to like elements, and are described in the context of a comprehensive device, system, and method for authoring and providing information to users about the physical world around the user. In this regard, the present invention generally provides information through interaction with labels, such as, but not limited to, machine-readable or human identifiable labels on physical objects, coordinate labels representing spatial or geographical locations, and time labels, preferably in the form of timestamps created by an internal or external clock source. All labels are treated uniformly as object, location, or time identifiers, i.e., each label serves to identify an object, location, or temporal event. To simplify the present disclosure, the use of the term object identifier collectively refers to object, location, or time identifiers. These object identifiers are more specifically used within the system, in a manner to be described in greater detail hereinafter, to perform various indexing operations such as, content authoring and playback, and user annotation and feedback. The present invention is also capable of aggregating object identifiers and their associated content into a single addressable database or information library referred to hereinafter as a “tour.”

To provide a comprehensive system and method for providing information to users about a physical world, and to allow users to record their own impressions of the physical world, the system preferably operates in two modes, namely, an authoring mode and a playback mode. The authoring mode permits new media content, e.g., audio, text, graphics, digital photographs, video, and various other types of data files, to be recorded and bound to an object identifier. In the authoring mode, the system supports content authoring that can be done coincident with object identifier creation, thereby enabling authored media content to be unambiguously bound to an object identifier. In other words, direct correspondence is maintained between physical object, location, or timestamp labels and respective media content. The playback mode triggers playback of media when an object identifier is accessed or detected. In the playback mode, the system can also be programmed to accept or solicit annotations and/or feedback from a user to be recorded and further unambiguously bound to an object identifier. Annotation and feedback may be in the form of user responses to objects encountered. The difference between annotation and feedback is fairly small in that the user generally owns or retains rights to annotations while feedback is typically owned by the person who solicited the feedback. Also, feedback may be interactive, such as, a user responding to a sequence of questions.

The following description is intended to provide a general overview of a suitable computing environment in which the invention may be implemented. Although not required or limited as such, the invention is described in the context of computer-executable instructions being executed by one or more distributed computing devices. The computer-executable instructions may include routines, programs, objects, components, data structures, and the like that perform particular tasks or implement data types. Moreover, the present invention may be operated by mobile users through the implementation of portable computing devices, such as, but not limited to, hand-held devices, voice or voice/data enabled cellular phones, smart-phones, notebook computers, computing tablets, wearable computers, personal digital assistants (“PDAs”), or special purpose built devices. These devices may be configured with or without a wireless network interface. The inventive concept may be practiced in distributed computing environments where tasks are performed by computing devices that are linked, preferably through a wireless communications network where computer-executable instructions may be located in both local and remote memory storage devices.

According to a preferred embodiment of the invention, FIG. 1 illustrates portable computing device 105 in a network architecture in which a tour server side is coupled to a client side via wireless distribution network 115. Wireless distribution network 115 is preferably a voice/data cellular telephone network, however, it will be apparent to those of ordinary skill in the art that other forms of networking may also be used. For example, the network can use wireless transmission networks based on, but not limited to, radio frequency (“RF”), 802.11 standard, and Bluetooth, in for example, a wireless local area network (“WLAN”) or personal local area network (“WPAN”).

Connected to the wireless distribution network 115 on the client side of the network are one or more mobile users who may roam indoor and/or outdoor locations to move among one or more objects 107 in the physical world. As will be described in greater detail below, locations 108 and/or objects 107 in the physical world can be represented by one or more machine readable or identifiable object identifiers, such as, barcode labels, RFID tags, IR tags, Bluetooth readable tags, analog to digital convertible tags; and/or further associated with human identifiable text, location coordinates, and timestamps. Timestamps generated by internal clock 109 on mobile device 105 can serve as labels in their own right or can be considered to be qualifiers to the media content bound to an object or a place. By way of example only, media content qualified by a timestamp could be information pertaining to a mountain resort location where winter information could be different from summer information.

Location coordinates 108 representing, for example, latitude, longitude, and optionally altitude, are determined by a location determination unit coupled with the mobile device using signals transmitted by GPS satellites or other sources. In other embodiments, location of the mobile device is determined by other conventional location determination schemes. In yet another alternative embodiment, the location coordinates can be provided by a remote server, and any mobile device requiring such data can receive the location data request from the networked remote server. This is especially useful when the mobile device does not have location identification capability, or in indoor facilities where GPS satellite signals are obscured.

To read the object identifiers, personal mobile device 105 comprises capture circuitry 110 that is adapted to respond to location coordinates 108 or labels 106 attached to physical object 107. Capture circuitry 110 may comprise a barcode reader, RFID reader, IR port, Bluetooth receiver, GPS receiver, touch-tone keypad, any analog to digital transducer than can transform label information to digital data, or any combination thereof. In the networked environment, personal mobile device 105 runs a thin or applet client system 104 with input and output capabilities while storage and computational processing takes place on the server side of the network. The client system may include a wireless browser software application such as a wireless application protocol (“WAP”) browser, Microsoft Mobile Explorer®, and the like, and support communication protocols implemented on any type of server well known in the art, such as, but not limited to, a WAP or hypertext transfer protocol (“HTTP”) based server.

In a networked environment, tour 103 is transported via path 113 between remote server 114 and mobile device 105 by wireless network 115. In the specific case where tour application 104 is implemented on a phone, the application may run both remotely in the context of a Voice extensible markup language (“VoiceXML”) browser or locally on the device. Index table repository 116, to be described in greater detail hereinafter, may be either locally resident or remotely accessed via data path 112. Similarly, the multimedia content collection associated with an object identifier may be either locally resident on the device or downloaded or streamed via path 113 with the aid of content proxy 117.

In an alternative embodiment, a wired network may be substituted for all or part of the wireless network. For example, transfer of tour 103 may be implemented by a modem connection (not shown) between mobile device 105 and remote server 114 or indirectly using an intermediary system 100 using data paths 102 and 101. Moreover, a tour may be authored on a host computer using a client authoring system 100 and either transferred to the device using data path 101 or uploaded to the server using data path 102 for subsequent download later to another mobile device. Further examples of transferring a tour from a mobile device to a host computer via wired connections are described in greater detail below.

In the remote server playback case, the connection between server 114 and mobile device 105 need not be held for the duration of the entire tour. For example, the server can maintain the state of the last rendered position in the tour across multiple intermittent connections permitting the connection to be re-established on a need basis. The state maintenance not only avoids the user having to log back in with a username/password, but puts the user right back to the last location in the tour, much like a compact disc (“CD”) player remembering the last played track on a CD. If mobile device 105 is a suitably adapted cellular phone, the server can use the caller's phone number to identify the last tour the user was in. In certain scenarios where the caller's phone number cannot be identified, a user would be prompted for a username and password and would be immediately taken to the last tour context. This functionality not only saves on the connection time costs, but also is effective for certain applications such as a tour implemented for providing driving directions using VoiceXML.

For tour authoring and publishing purposes, mobile device 105 comprises a universal serial bus (“USB”) connector so that the mobile device can be directly connected via path 101 to host computer 101. In an alternative embodiment where the personal mobile device does not have an USB connector, upload of the tour to a host computer can be implemented using a conventional data output, such as, an audio headphone output connected to the microphone input of a PC. Although such a scheme may result in some audio quality degradation in the re-recording process, it would serve as a safe-backup of valuable content on a PC. When sequential playback is initiated in a particular device mode, referred to as an “upload playback mode,” the index values of a tour are sent as specialized tones whose frequencies are chosen so to not collide with human speech. Special software running on the PC recognizes the alphanumeric index delimiters between content and regenerates a tour. The alphanumeric indices values could represent normalized label values, such as, timestamps, barcode values, or coordinates.

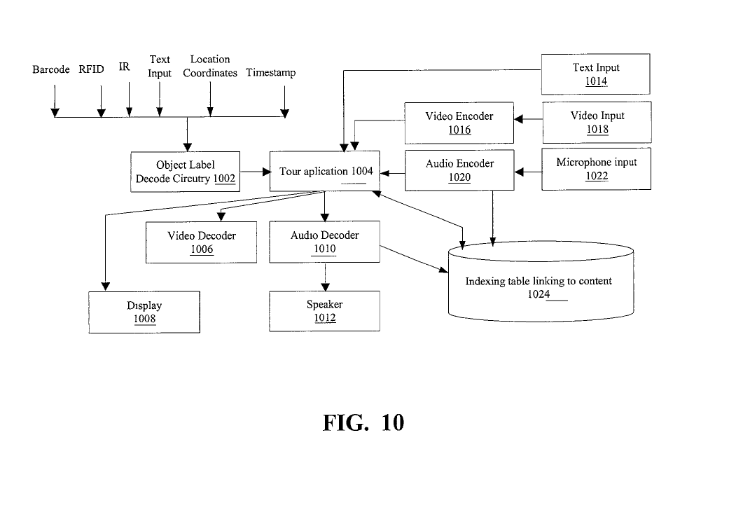

To provide for the authoring and/or playback of media content related to one object identifier or a plurality of object identifiers associated with a tour, personal mobile device 105, examples of which are illustrated in FIGS. 10-12, preferably includes object label decode circuitry 1002 that is adapted to read/respond to barcode information, RFID information, IR information, direct or indirect (obtained from an analog to digital transducer) text input, geographic coordinate information, and/or timestamp information. The object label decode circuitry 1002 provides input to tour application 1004 resident on the personal mobile device 105. The tour application, which will be described in greater detail below, generally responds to the input to initiate the authoring or rendering of media content as a function of the object label read. For playing the media content, the personal mobile device 105 comprises video decoder 1006 associated with display 1008, and an audio decoder 1010 associated with a speaker 1012. Display 1008 may be a visual display such as liquid crystal display screen. In an alternative embodiment, the device can function without a visual display.

For inputting information which may be bound to an object identifier, personal mobile device 105 comprises a means for inputting textual information via, e.g., keyboard 1014, a pointing device in the form of a pen (not shown), a touch sensitive screen that is part of display 1008; means for inputting video information via, e.g., video encoder 1016 and video input 1018; and/or means for inputting audio information via, e.g., audio encoder 1020 and microphone 1022, or touch-tone buttons, such as, dual tone multi frequency (“DTMF”) buttons (not shown) for phones.

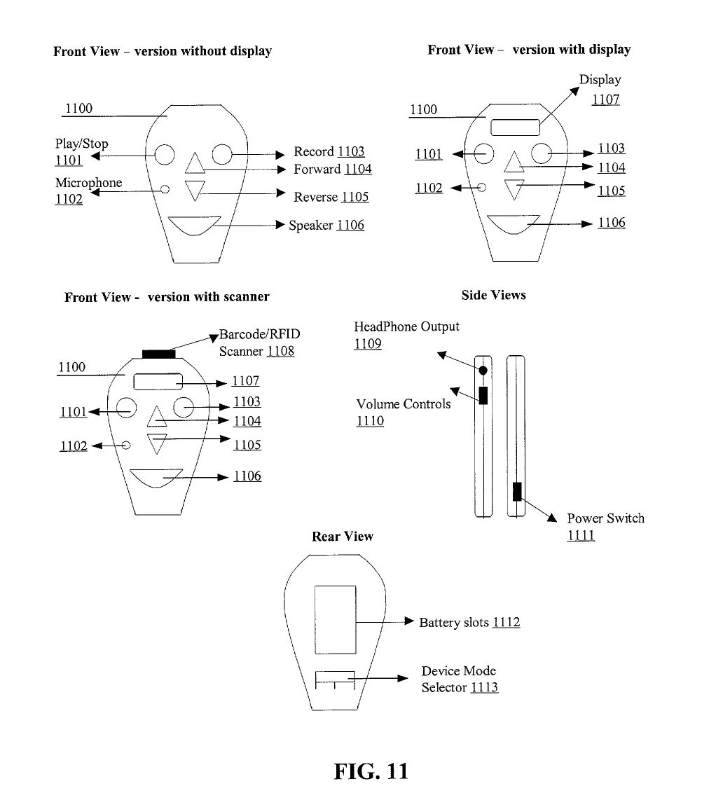

Referring to FIG. 11, personal mobile device 1100 comprises media content control keys such as, play/stop 1101, record 1103, reverse 1105, fast forward 1104, volume controls 1110, and various other operations can be provided for use in interacting with media content. In this manner, the various control keys can be used to selectively disable device functionality in certain device modes, particularly playback mode, using hardware button shields, device mode selectors, or embedded software logic. Personal mobile device may 1100 may further comprise one or more of the following: an audio input, e.g., microphone 1102; audio output, e.g., speaker 1106 or headphone output 1109; barcode and/or RFID scanner 1108; display 1107; power switch 1111; battery slots 1112; and device mode selector 1113 for alternating between authoring and playback modes.

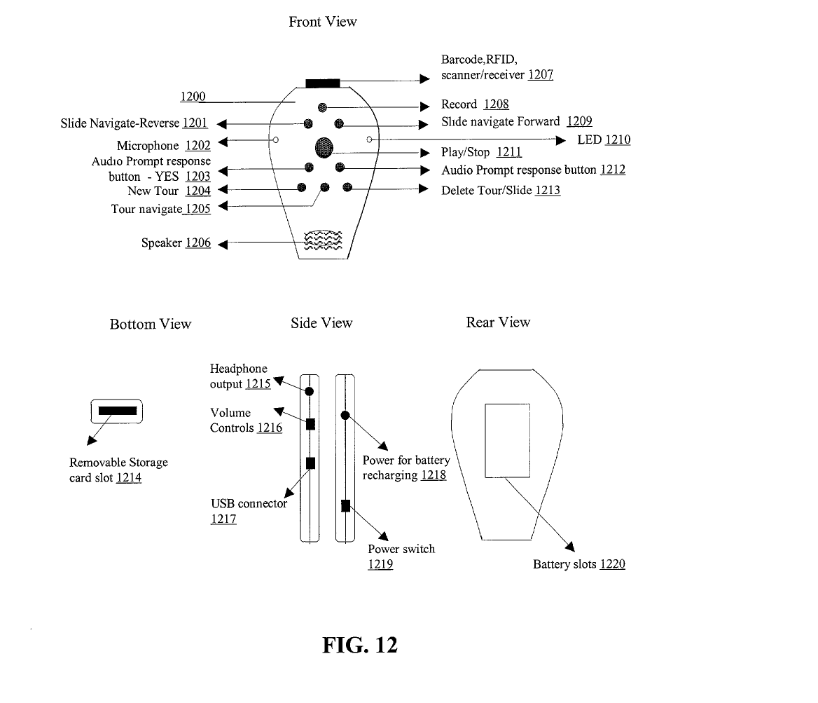

Referring to the alternative embodiment depicted in FIG. 12, mobile device 1200 comprises media content control keys such as, play/stop 1211, record 1208, reverse 1201, fast forward 1209, volume controls 1216, and various other operations that can be provided for use in interacting with media content. In addition, the device 1200 comprises audio prompt response buttons 1203 and 1212 for responding to audio questions posed by the device. Also the device may have tour based operations, such as, new tour creation button 1204, tour navigation 1205, tour/slide deletion 1213. Personal mobile device 1200 may further comprise one or more of the following: an audio input, e.g., microphone 1202; audio output, e.g., speaker 1206 or headphone output 1215; barcode and/or RFID scanner 1207; power switch 1219; battery slots 1220; removable storage 1214; USB connector 1217; power for battery recharging 1218; LED 1210 for visual cues.

The inventive concept can be implemented on any type of computing device, ranging from existing portable computers, PDAs, and cellular phones, to a purpose-built, i.e., custom made, device. Because a tour application does not mandate the implementation of all object identification schemes, mobile personal device 105 may implement the label identification schemes most suited for the particular device capabilities and usage context. Also, mobile personal device 105 may only support the authoring and/or rendering of particular media. For example, for those mobile devices that do not have the resources, e.g., a resource-constrained phone, to support the full capabilities of the tour application, a tour application proxy could be built for the device, and the resource intensive processing takes place on the server side. Further, the implementation of tour application proxies 116 and 117 is done based on the storage and computing resources of the device. For example, in one embodiment, index table 116 is composed of object identifiers that are locally resident, but multimedia content collection 117 is remotely resident. In another embodiment, index table 116 is also remotely resident, i.e., the proxy directs all normalized input obtained from a label detection scheme to remote server 114. The latter embodiment may be preferred on resource constrained devices such as cellular phones. For a device that has enough computing and storage resources, both components of the tour, index table repository 116 and multimedia content collection 117 can be locally resident on the device.

Turning to the tour application, tour application 1004 preferably includes executable instructions that can create and modify a tour tree structure, which is discussed in greater detail below, for performing various tour operations such as, but not limited to, tree traversal, tree node creation, tree node deletions, and tree node modifications. Index table 1024 liking content to the tour and the media may be either locally resident or remote on a server. Tour application 1004 supports authoring, playback, annotation, and/or feedback of a tour. Tour application 1004 may also support the transformation of a tour from one particular format to another. It will be understood that tour application 1004 can work in connection with a proxy to perform these functions. Still further, tour application 1004 can be a stand alone module or integrated with other modules such as, by way of example only, a navigation system. In this latter instance, while the navigation system would provide the details of how to get from point A to point B, tour application 1004 could provide information pertaining to locations and objects found along the path from point A to point B.

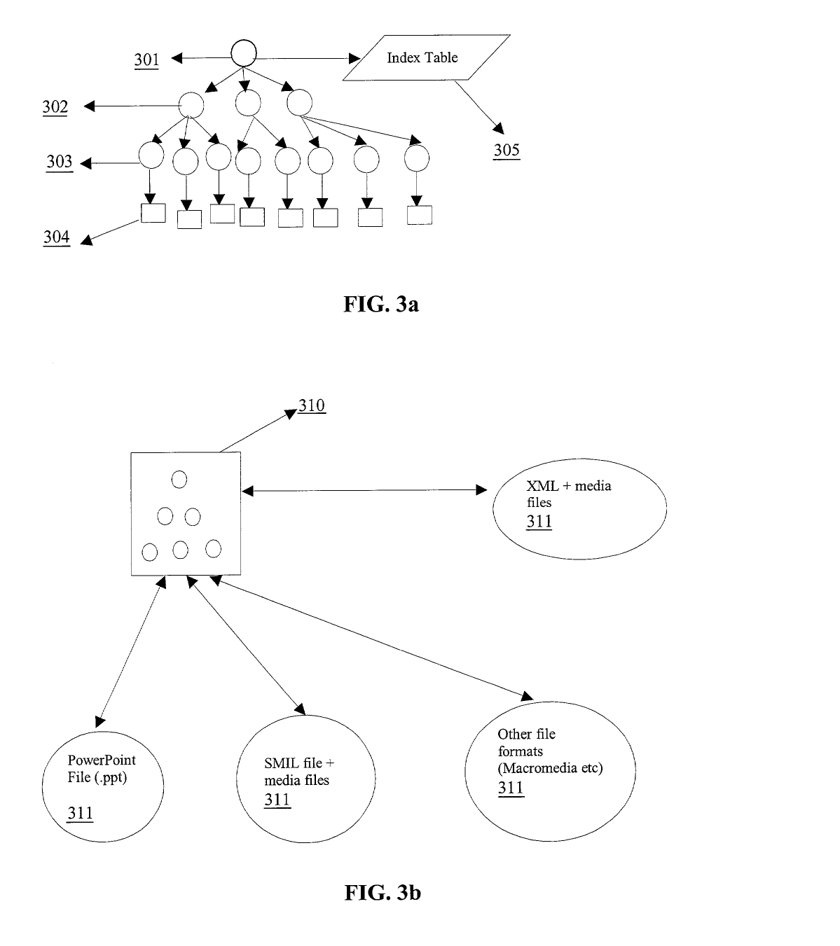

To provide information to a user via a mobile personal device, and as noted previously, the system may use the concept of a “tour,” which can be considered to be an ordered list of media content that are indexed by object identifiers created from for example, text strings, physical object labels, coordinates of geographical locations, and timestamps representing temporal events. In this regard, the media content may optionally further contain annotations and feedback. Annotations and feedback are also lists of media content. Media content can further be considered to be an ordered list of digital content in text, audio, graphics, and/or video stored in various persistent formats 311 such as, by way of example only, XML, PowerPoint, synchronized multimedia integration language (“SMIL”), and the like, as illustrated in FIG. 3b.

In a particular embodiment, a tour is implemented as a collection of multimedia digital information, where the multimedia content is indexed by normalized labels, i.e., object identifiers generic to two or more interpretation schemes, stored in index table repository 116. The digital information includes audio files, visual graphics files, text files, video files, multimedia files, XML files, SMIL files, hyperlink references, live agent connection links, programming code files, configuration information files, other data files, or a combination thereof. Various transformations can be performed on the multi-media content. For example, recorded audio is transcribed into a text file. The advantage of content format transformations is to allow accessing the same tour with mobile devices of different capabilities and/or according to user preference. An example of this is accessing a tour using a voice only cellular phone or accessing the same tour with a PDA with display capabilities.

The aggregation of media content can be done to any depth as deemed appropriate to the application context. This is particularly illustrated in FIG. 3a, which depicts an exemplary instance of a tour in the form of a tree data structure. The nodes of the tree are tour node 301, channel node 302, slide node 303, and media node 304. Particularly, media node 304 comprises or links to text, audio, video, graphics, and other data. Slide node 303 points to one or mode media nodes 304. Channel node 302 aggregates one or more slide nodes 303. This aggregation is to facilitate logical grouping of content within a tour. For example, in a museum-specific tour, all exhibits within the Science section may be grouped into a channel 302. Tour node 301 aggregates all channel nodes 302 into the complete structure that constitutes a tour. In the exemplary instance of a tour shown in FIG. 3a, index table 305 is associated with the tour tree. The flexibility and richness of the tour data structure enables various transformations of tour 310 between different file formats 311 as illustrated in FIG. 3b.

Index tables 305 are particularly used to gain access to the media content associated with a tour. In this regard, an indexing operation, performed in response to the reading of an object identifier, can result in a tour, slide, or channel being rendered on mobile personal device 105. As noted previously, the tour, slide, or channel can be provided to mobile personal device 105 from the server side of the network and/or from local memory, including local memory expansion slots.

The nodes of the tour hierarchy can contain information appropriate to a given application which can use a logical structuring of information without regard to file format specifications or physical locations of the files. Accordingly, there may be several physical file implementations of a tour and, so long as the structural integrity of the tour is preserved in a particular implementation, transformations can be done between different file formats. However, it is cautioned that, during a transformation, some media content types may be inappropriate or “lost” since the destination mobile personal device may not support some or all of the media content in a tour. For example, a mobile personal device without a display and only audio capabilities would be limited to presenting tour media content that is only in an audio format.

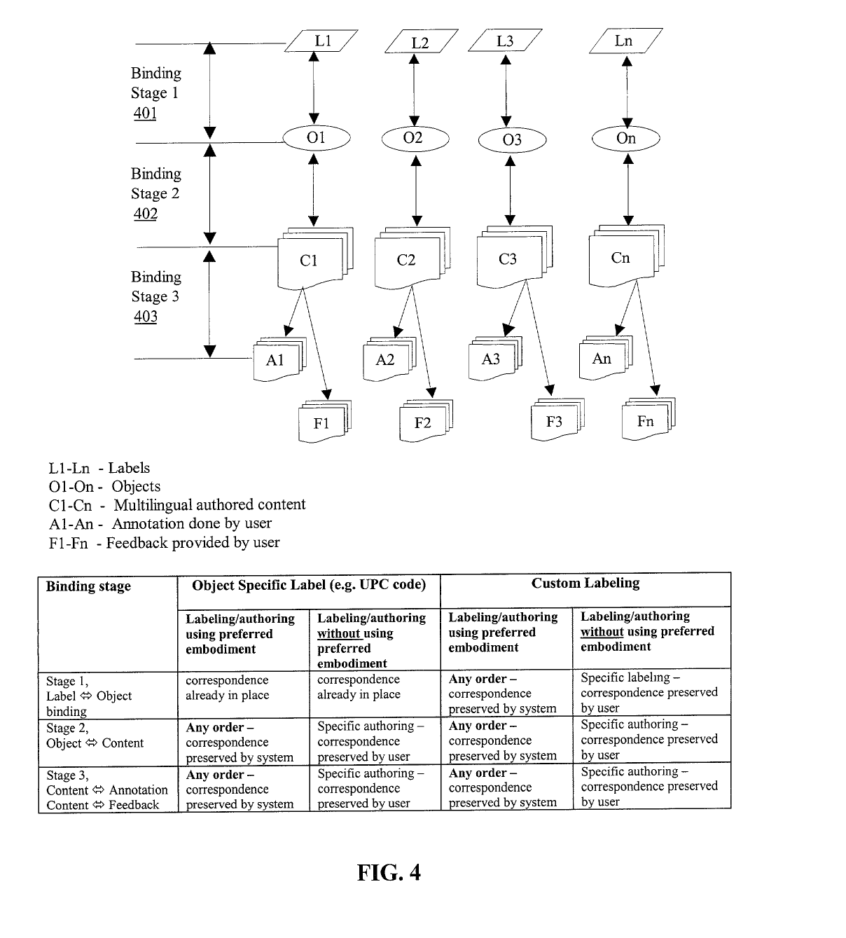

To author a tour containing information about physical objects, locations, and/or temporal events (collectively referred to as “entities”) in the physical world; the entities are labeled with labels that are treated uniformly as object identifiers. The object identifiers are stored within the system and media content for an entity is bound to its corresponding object identifier. When assigning labels to objects, generally illustrated at stage 401 in FIG. 4, objects that do not have a preexisting label are provided with a customized label. Objects with preexisting labels can include items that have UPC coded tags. Example of custom labeling would be the labeling of a picture in a photo album or a paragraph in a book. It will be appreciated that, even for objects that have preexisting labels, custom labeling can be done if desired. The remaining stages illustrated in FIG. 4 include stage 402 where objects/object identifiers are bound to media content and stage 403 where optional feedback and annotations can be bound to objects/object identifiers.

To label geographical location, location coordinates are introduced. In authoring mode, an authoring device, such as a personal mobile device, determines its current location coordinates using GPS or similar technology, or using information available from the wireless network. The computer coordinates may then be used as the object identifier for the geographic location. The author may bind media content to coordinates the same way as any other label. Furthermore, the usage of coordinate data does not require the exact coordinate to be available to initiate playback of the media content bound to the coordinate. Rather, a circular shell of influence may be defined around the coordinate that can trigger playback of the media content. For simplicity of authoring, it is preferred that the shell of influence be a planar projection of the coordinate thereby eliminating the need to consider altitude variations.

It will be further appreciated that various concentric circular shells of influence may be defined around a coordinate label and can be bound to unique media content. In this manner, entry into these various shells can trigger audio and/or visual content authored explicitly for that shell. This can be particularly useful in gaming applications such as, for example, a treasure hunt.

Temporal events require no further labeling, i.e., the timestamp can serve as the label itself. In this regard, timestamps can be used to label both periodic and aperiodic temporal events. Furthermore, even when labeling aperiodic events, timestamp labels can have an artificial periodicity associated with them to serve as a reminder of past events. In an embodiment of the invention, an internal clock within personal mobile device 105 is used to check the validity of timestamp labels which, when read and if valid, can initiate content rendering in playback mode. When using timestamps to label aperiodic events, the timestamps are used as secondary labels to a primary label such as a physical object label or location coordinate. Such labels are thus identified as a consequence of identifying the primary label.

Text strings can directly serve as labels for indexing media content. For example, text strings may be the output of a transducer that can transform any non-digital data into digital data, for example, a text string or any other computer specific data type that can represent the digital data. By way of further example, an instance of a tour can be a hierarchical set of markup language, e.g., XML or hyper-text markup language (“HTML”), pages combined with one or more index tables. With the addition of index tables and ordering of the pages, an existing web site could be implemented as a tour where all indexing is done using text strings.

A labeling scheme for physical objects can range from manually writing down a code on an object to tagging the object with a barcode, RFID tag, IR tag, or any conventional type of identification means. For scenarios that need custom labeling, the labeling can be done in any order regardless of the labeling scheme being used. This eliminates the need to maintain an extraneous order between labels and objects which, in turn, eliminates errors in the labeling process.

In an embodiment of the invention, data structure representation for a normalized label is a variable length null-terminated string. Alternatively it could be any data type that can represent the digital data that was retrieved from the label, the retrieval being followed by an optional transformation of non-digital data into digital form. For example, when a barcode label is scanned, the scanning device returns the label in a device specific manner, which is then transformed by the normalization process into a null terminated string. For example, if the value encoded on the barcode label was the UPC code of a particular product, after normalization, it would become a numeric string, such as, “05928000200,” which does not reveal any information about how the value was retrieved because normalization strips out all information about the particular label retrieving process. These normalized or generic strings, also referred to as object identifiers, are then used as indices for organizing authored content.

During content authoring, since labels are normalized into object identifiers, multiple labeling schemes may be used to access the same piece of media content, provided the data encoded by these labeling schemes yields the same value after normalization. For example, an object can be labeled by associating a UPC text stream therewith and media content bound to the object can be retrieved by entering the same UPC text stream or by scanning a UPC bar code corresponding to the UPC text stream. In a further example, a coordinate obtained from a GPS type device may be embedded into a barcode label, an RFID tag, or even etched into an object. Thus, in playback mode, a personal mobile device 105 with any one of the label detection capabilities, e.g., barcode reader, RFID tag reader, IR port, digital text or analog to digital text transformation capabilities, can be used to retrieve media content bound to the object identifier corresponding to the object since, in this case, the information that is embedded into the different labels is a normalized form of label data, namely, the coordinate. For multiple labeling schemes to index the same object the data in multiple labels, the scheme should be such that they all result in the same normalized value. In the above example, the barcode label, and the RIFD tag, embed the same value, e.g., location coordinates.

Just as multiple labeling schemes result in the same normalized index value (referred to as the object identifier), multiple distinct object identifiers can refer to the same object. An example illustrates the difference between multiple labeling schemes used to yield the same object identifier, and multiple distinct object identifiers indexing the same object. Consider a street with an embedded RFID tag. The coordinate values returned by a GPS device are embedded into the RFID tag. Content is authored for the normalized value—the coordinate. A user may also create a text-string label for that street name and bind the normalized version of that label to the same content. When a user of the tour comes to that location, he could access the content using either a GPS device or a RFID reader. Alternatively, he may read the street name and enter the street name to access the same content. In this case, the GPS and RFID labeling schemes yield the same normalized index value. The text string labeling results in a different labeling value that indexes the same content.

Further, if the device only has location determination capability and a text input mechanism, the location of the user could be used to narrow down the object identifier search space. An advantage of this type of functionality is that it can be used for automatically listing all objects in the proximity of the user. In those scenarios where there are a large number of objects, the culled search space could help the user by auto-completion of the street name as he types it in (in the case of the device with keyboard input scheme), or unambiguously recognize the street name (in the case of the device with speech recognition capability) vocalized by the user. In this scenario, two object identifiers are used in both authoring and playback. In the playback mode, one of the object identifiers (location coordinates) is used to aid the detection of the other (the street name text string).

A special case of multiple labeling methods being used to refer to the same media content is the functionality to index any tour with an ordinal index value of the content, the implicit ordering of content present in a tour. This ordering provides an alternate way to get to authored content regardless of its normalized labeling method. This is a special case because the normalized label is a digital text string representing the ordinal index of the content which may not be the same as the normalized index type explicitly used during authoring. For example, content authored with coordinates being used as the normalized value can be retrieved using the ordinal index value for that content.

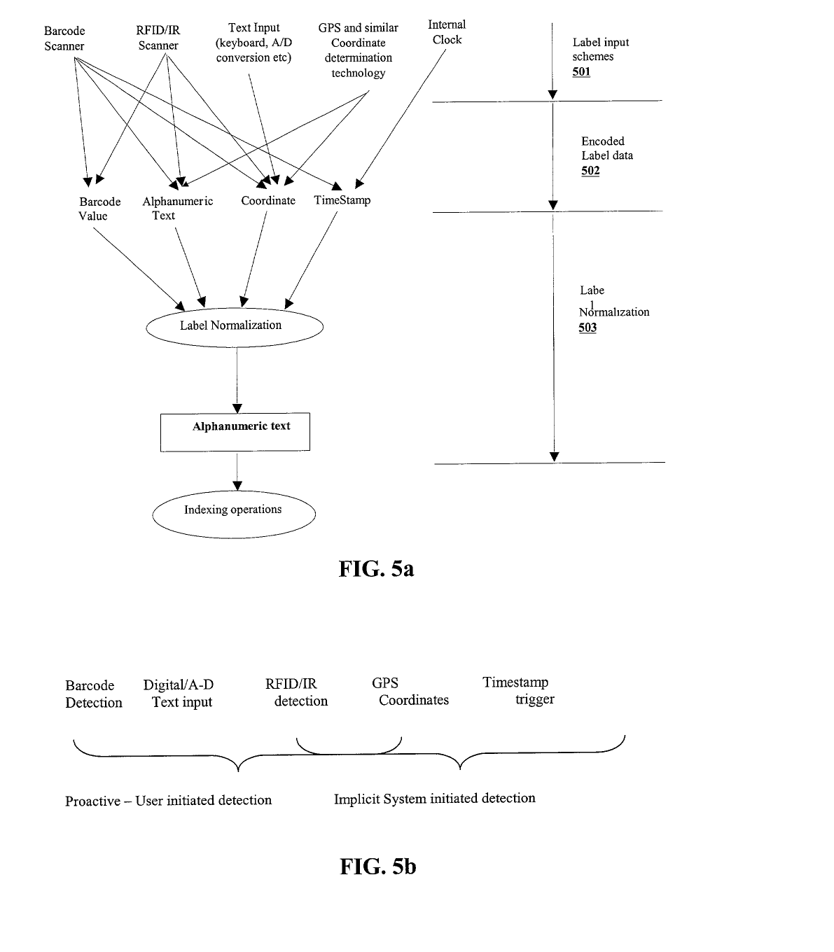

To access and/or author media content, a label identification process is performed as illustrated in FIG. 5a. The outcome of the label identification process is an object identifier that can be used for indexing. As illustrated, the object identifier is independent of the label type. Furthermore, as noted above, different kinds of label input schemes 501 can be used to detect and retrieve different types of labels 502 and the normalization process 503 yields a normalized index value. The data returned from the label normalization process 503 may be represented by any computer support data type and not limited to a alphanumeric string.

In the authoring mode, label identification is done proactively by the user either manually or with the aide of an apparatus, such as a bar code scanner, optical scanner, location coordinate detector, and/or a clock. An object identifier can be used to generically represent one or more of these identified labels. Specifically, an object identifier can be used as a normalized representation of different labels and, thereby, can serve the key purpose of allowing different labels to uniformly index media content in a manner that is transparent to their underlying differences. Furthermore, as noted previously, since labels are treated in a normalized manner, it is possible for label detection to be performed differently during the authoring and playback operations.

To maintain the association between an object identifier and media content for an object, an index table is created during the authoring mode of operation. When a label is identified and an object identifier created, search 111 is done for the object identifier in index table repository 116. If the object identifier is not already in index table repository 116 the object identifier is added to the index table repository 116. As an example only, the index table repository 116 can be implemented using index tables and flat files, relational or object based database systems, and the like.

Once an object identifier is identified within index table repository 116, media content can be mapped to the object identifier. As noted previously, the media content can be in one or more formats including text, audio, graphics, digital image, and video. Multiple media content can be associated with the same object identifier within a index table repository 116 and can be stored in one or more locations. To remove errors in the indexing process, such as associating media content with the wrong object identifier and, accordingly, the wrong object, when a new object is identified in the authoring mode, the system can create a new entry in the index table repository 116 and immediately prompt the user to author/identify media content that is to be associated with the object identifier. This coincident object identifier creation and authoring/identifying allows media content and object identifier binding to occur nearly instantaneously.

The advantage of the labeling and media content scheme described above is particularly seen in practical applications such as, for example, home cataloging situations where picture albums, CD collections, book collections, articles, boxes, and other articles are organized. It also finds use in commercial contexts, both small and large, where a vendor might wish to provide information on objects being sold. An example of a small commercial context usage is an antiques vendor labeling his articles and/or parts of articles and associating media content therewith that might explain historical significance. In this regard, the objects can be quickly labeled in any order and have content quickly and easily associated therewith. In a larger commercial context, a vendor can author daily promotions and sales information by scanning a label associated with an object and associating media content describing the promotion and sales information with the object.

While index table repository 116 can be created using a host computer, it is preferred that index table repository 116 be created using the mobile personal device 105. To this end, the mobile personal device allows the user to read the label and author the content that is to be associated with the read label. The mobile personal device 105, or the server side components, will then automatically map the content and the created object identifier to each other within index table repository 116. It will be appreciated that this makes the binding of coordinates particularly easy since the content author can directly create content to be mapped to the coordinate at that very location. A particular example of this would be a real estate agent creating a tour of a home while touring the home. It would also be possible for a potential homebuyer to author feedback which can also be mapped to the coordinates as the potential homebuyer tours the home.

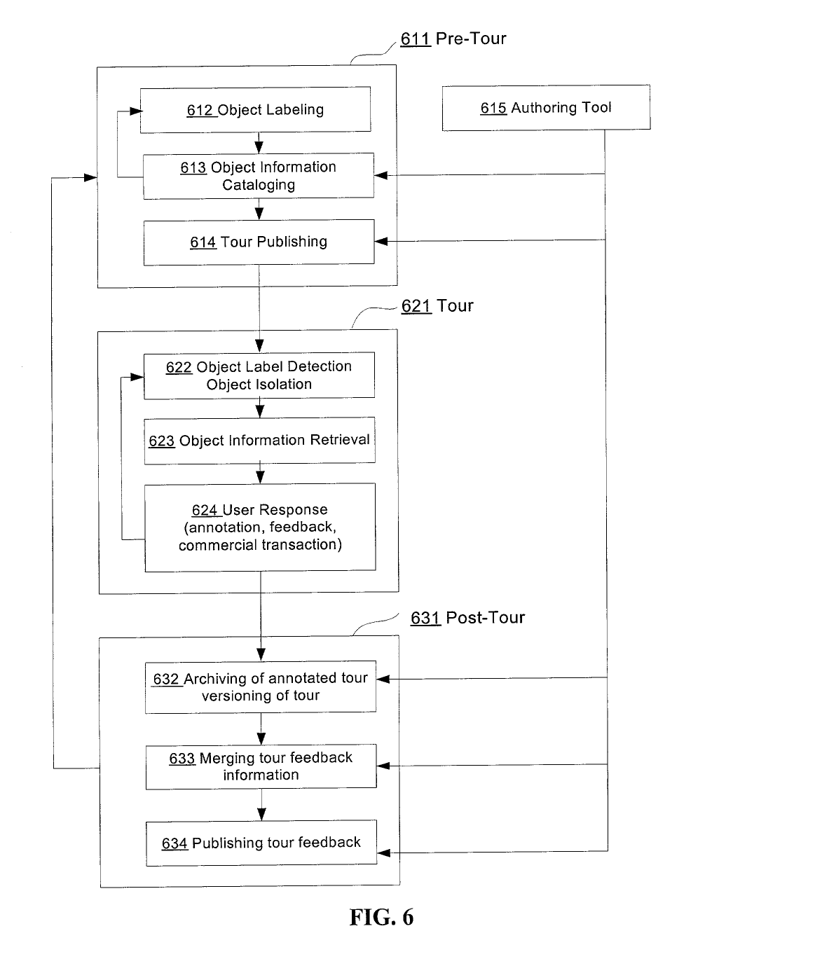

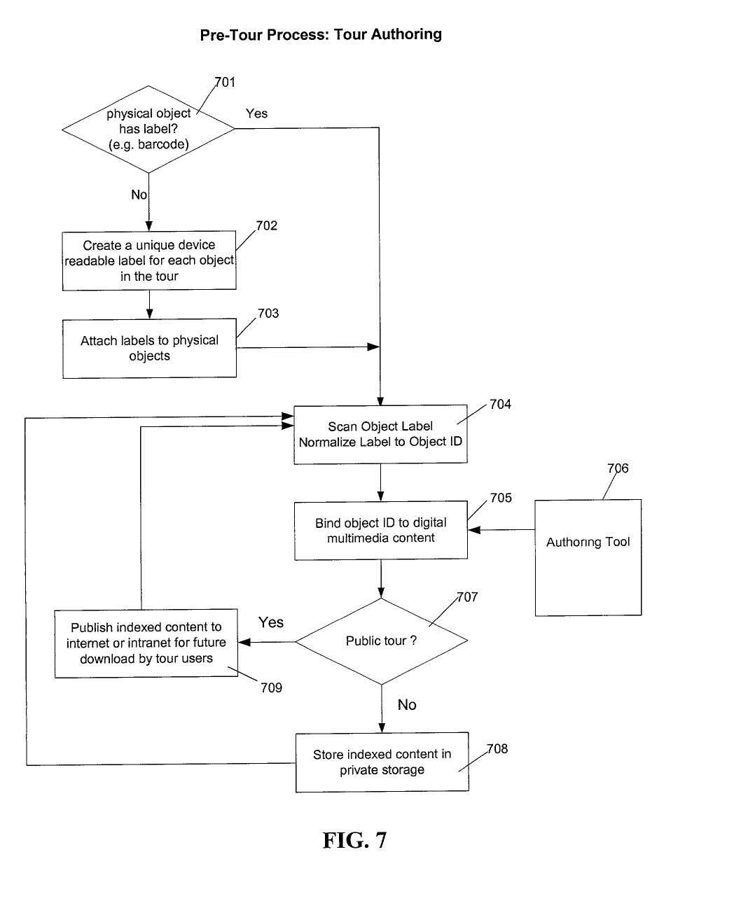

The process for authoring a tour is generally illustrated as steps 612-614 in FIG. 6 (pre-tour 611 being performed with the assistance of authoring tool 615) and steps 701-709 in FIG. 7. Authoring process 611 begins by labeling (step 612) objects if they do not already have a label or require application specific labeling. Steps 701 and 702 correspond to these steps for an object that does not have a label. The labeling of objects (step 703) can be done in any order. Subsequent to the labeling, in the object cataloging (step 613), an index table is created using the label indices obtained by scanning the object labels and normalizing the retrieved labels (step 704). Simultaneous to the label detection, content is authored and bound to these indices (step 705). The authoring process could done by authoring tool 706 that is resident on the mobile device. The final step in the tour authoring process involves publishing it, which could range from saving it in local storage or downloading to a mobile device or uploading it to a server. The storage choice would be determined by the author of the tour. An author chooses to make some or all of his tours private or public (step 707). A private tour does not mean that it cannot be stored on a server, but rather refers to generally that only particular authorized users may view the media content typically stored in a private secure storage (step 708). User authorization and data verification can be performed using conventional techniques. Moreover, security of the media content can be enhanced by implementing one or more cryptographic techniques, such as, but not limited to, symmetrical or asymmetrical encryption, digital signatures, hashing, and watermarking. Where security is not of concern, public tours can be freely accessed by the public (step 709). In an embodiment of the invention, access to the tour is granted upon a user's payment of a fee.

Still further, browsed web pages can be aggregated into a tour since the browsing process creates an ordering of content and an index table with the links that were traversed during the browsing. Moreover, it is also possible that all hyperlinks in the pages visited could be automatically added into the index table. The browsed content can then be augmented with annotations and feedback which are bound to indices accessed in this browsing sequence. Thus, playback of one or more tours or conventional web browsing can be treated as an authoring of a new tour that is a subset of the tours and web pages navigated in playback mode. This functionality is very useful to create a custom tour containing information extracted from multiple tours and conventional web pages.

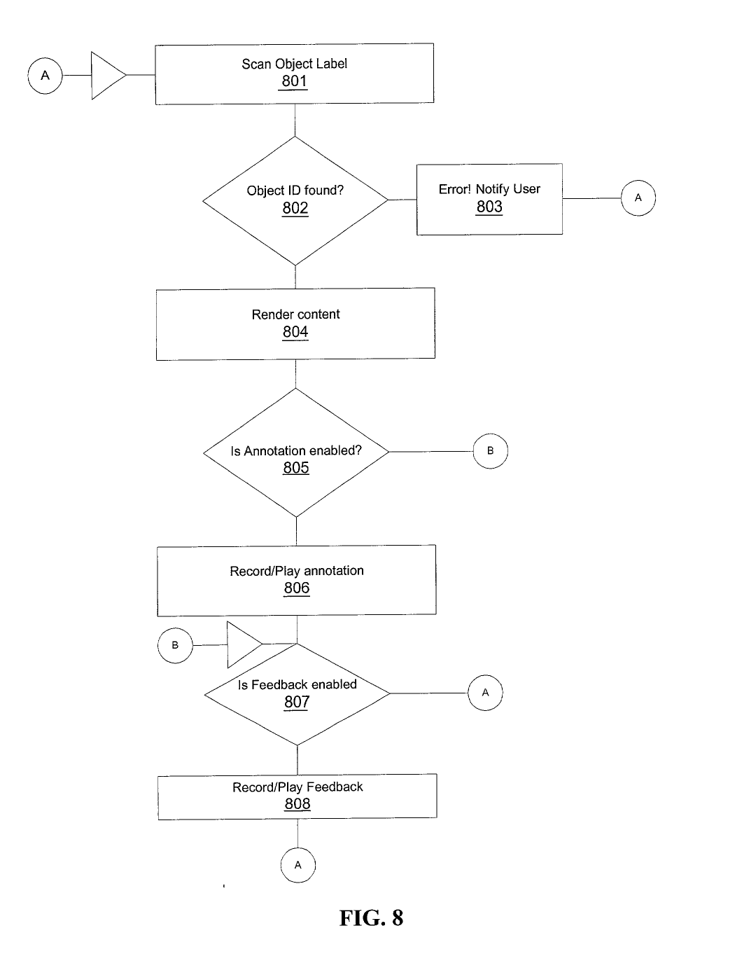

To playback media content that has been mapped to an object identifier within an index table repository, the system determines the object identifier for a read label, searches for the object identifier in a index table repository, retrieves the media content associated with the object identifier, and sequentially renders the media content on the personal mobile device. This is generally illustrated in FIG. 6 as steps 622-624 related to tour process 621 and as steps 801-804 illustrated in FIG. 8. The first step in tour playback is the label detection (steps 622 and 801). The normalized label is then used to index an index table repository. If the index is found (step 802) it results in retrieval (step 623) of media bound to that index during authoring stage and rendition of the retrieved media (step 804). If the index is not found, a typical action would be to report an error to the user (step 803). The tour may be also authored to provide alternate index lookup schemes to find an unmatched index such as, for example, an index search in select URLs. If the index is found, then that index can be added to the tour's index table repository and the content can then become part of the ordered elements of the tour. Subsequent to the rendition of the retrieved media, the tour may have been authored to solicit/accept feedback/annotation (step 624) from the user. It can also result in initiating a live connection with a remote human or automated agent which may culminate in a commercial transaction. During the playback mode, it is preferred that, if the same media content is being indexed by the reading of multiple labels repetitious playback of the same content is avoided.

Label identification in the playback mode is virtually the same as the label identification in the authoring mode. While label identification initiates object creation in the authoring mode, label identification initiates label matching followed by media rendering (if the label has an object identifier) in the playback mode. Furthermore, in playback mode, in addition to manual label reading, label reading may be automatically initiated either by a location-aware wireless network, an RFID tag in the proximity of the device, or by an internal clock trigger system. As noted, the outcome of the label identification process is an object identifier that can be used for indexing media content.

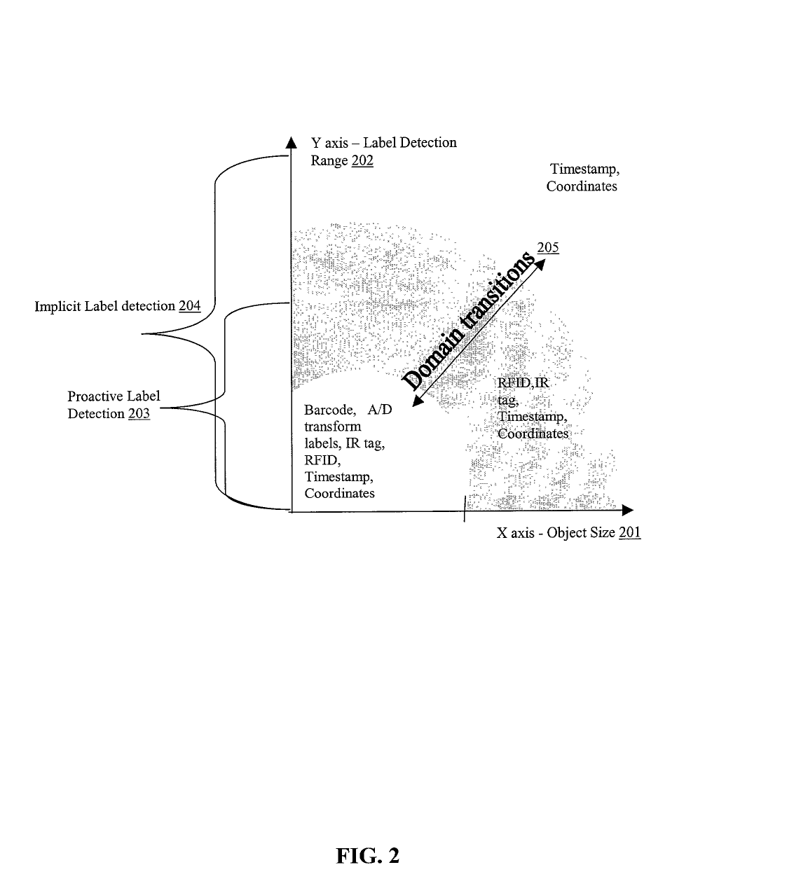

Once a match is found in the index table repository for the object identifier, media content bound to that object identifier can be sequentially rendered, provided that the media content is supported by the mobile personal device. Playback of media content can be triggered in three ways, namely, by a user manually initiating the label identification, by the automatic reading of a label, or by a sequential presentation, e.g., a linear traversal of elements of a tour. Referring to FIG. 2, the first two proactive methods 203 of triggering playback enable the tour to provide a user experience somewhat similar to having a human guide; the manual triggering being equivalent to the user asking a particular question and the automatic triggering 204 being equivalent to an ongoing commentary. Thus, the tour provides a richer user experience than the one provided by a human guide since these two methods of playback serve as two logical channels containing multiple media streams. To ensure that two channels do not conflict and the transition between these two channels is seamless, one channel can be designated as a background channel which has a lower rendering priority than the other. When a background feed is being inhibited as a function of its lower priority, an application may choose to provide a user with an interface cue (e.g., audio, graphics, text, or video) that indicates a background feed is available. FIG. 2 plots the object sizes 201 on the X axis and the Label detection range 202 on the Y axis. It illustrates that proactive label detection scheme works for small objects with low detection range and implicit label detection 204 works for large objects with longer detection range. Furthermore, as user moves between small and large objects with varying detection ranges, the transition between these domains 205 is made seamless by the background and foreground channel scheme as described above. The various label detection schemes that apply for these different domains are listed in FIG. 5b.

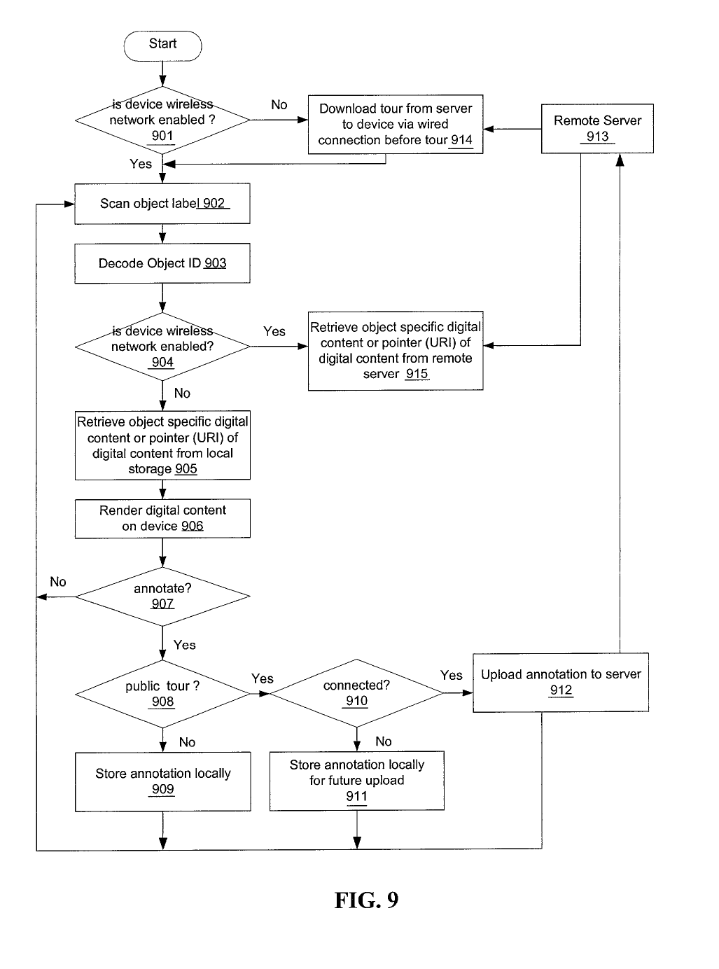

During the playback mode, generally illustrated in FIG. 9, a user may be given the ability to annotate content as particularly illustrated as steps 805 and 806 in FIG. 8. The media for accepting annotations depends upon the capabilities of the device that accepts the annotations. When multiple objects qualify for annotation, a user should be prompted to choose among these multiple objects. An example of this may arise when a user stopped playback of a manually scanned object and the location of the object happens to coincide with a coordinate for which content is available. Feedback, illustrated in steps 807 and 808 may be made an interactive process. Still further, the tour may also support the notion of a live-agent connection facility which enables the user to connect directly to a human agent to initiate a transaction. This is particularly useful when the mobile personal device is embodied in a cellular telephone. The user may initiate an electronic e-commerce transaction using the established connection, the connection being made to a live or automated agent.

As noted above, the authoring and playback of a tour imposes no constraints on the physical location of a tour or its contents, i.e., it could be locally resident on the mobile personal device or remotely resident on a server. When remotely located, the tour can be accessible by one of the several wireless access methods such as, WPAN, WLAN, and wireless wide area network (“WWAN”). Furthermore, the media content could be pre-fetched, downloaded on demand, streamed, etc. as is appropriate for the particular application.

Feedback and annotation provided in the context of a tour, the creation of which is generally depicted as 631 in FIG. 6 including steps 632-634, could also be resident in any physical location. In step 632, annotations and feedback are archived locally on the mobile device 105 or uploaded to a server 114 with time and version information that help identify their creation times. Since feedback and annotation may be hard to interpret separate from the tour due to a lack of context, annotation and feedback may be merged 633 with the tour. Since feedback/annotation is bound to object identifiers that provide the context for the annotation/feedback, it is also possible to create a tour subset of an original tour that contains only those elements which have annotation and feedback. This would be very useful if the user is interested not in recapitulating the entire tour but only those parts that were annotated or for which feedback was provided. To this end, a tour application running on a PDA, for example, can easily send the annotations and feedback to an appropriate destination as an email attachment for rendering by a party of interest as a new tour. In other forms, tour publishing 634 with feedback and annotation could be uploading to a server. An example of this usage is a parent annotating a child's language learning process, described in detail below. After the parent annotates the tour, the tour may be uploaded to a server 634 for sharing it with the rest of the family.

FIG. 9 illustrates usage of the system in both a wired and wireless network for playback of a tour. The steps listed here have been illustrated in detail in FIGS. 6-8. If the device is not wireless network enabled (step 901) then the tour is downloaded by a wired connection (step 914) from the network. The next step is to detect a label (step 902), decode and normalize the label (step 903), and in the wireless network case (step 904), download the media from the remote server (step 915). If the device is not network enabled, content is retrieved from local store (step 905) since it is has already been transferred by a wired connection. The content is then rendered (step 906). If annotation/feedback is enabled (step 907), then for a public tour (step 908), the annotation is uploaded (step 912) to server 913 if a connection (step 910) is available.

If a connection is not available, it is queued (step 911) for future upload. Annotation for private tours are stored locally (step 909).

The following description, with the aid of Tables 1 and 2 set forth below, generally describe applications in which a tour may be used.

TABLE 1
Application categories

| Type | Description of Application | Labeling scheme |
|---|---|---|
| 1 | Physical label-based applications | barcode, RFID, IR, text |
| | | strings, any label that can |
| | | be transformed to digital |
| | | data by some transduction |
| | | means, timestamp |
| 2 | Location-based applications | Coordinates, RFID, digital |
| | | text strings, any label that |
| | | can be transformed to digit- |
| | | al data by some transduc- |
| | | tion means, timestamp |
| 3 | Timestamp based applications | timestamp |
| 4 | Linear ordering based applications | no label, application |
| | | depends on linear ordering |
| | | of tour content. |

TABLE 2
Examples of Applications

| | | | | Device | | | |
|---|---|---|---|---|---|---|---|
| | Application | Application | Labeling | Purpose | | | Server |
| # | Name | Description | scheme | Built | PDA | Phone | Support |
| 1 | My First | Child's voice cataloging | Time-stamp | X | | | Optional- |
| | Words | while child is learning to | | | | | needed only if |
| | (Type 3) | speak. Parent can annotate | | | | | device has |
| | | shild's utterances | | | | | network |
| | | | | | | | connectivity. |
| | | | | | | | Content |
| | | | | | | | authored by a |
| | | | | | | | parent/child |
| | | | | | | | may be |
| | | | | | | | uploaded to a |
| | | | | | | | server using |
| | | | | | | | an |
| | | | | | | | intermediate |
| | | | | | | | host such a PC |
| 2 | Childs | Childs label based learning | Hand- | X | | | Content |
| | learning | device. Objects in the house | written | | | | authored by a |
| | device | are tagged by parent. Child | labels | | | | parent/child |
| | (Type 1) | identifies the distinctive | (numbering) | | | | may be |
| | | tags on object and scans | or Barcode | | | | uploaded to a |
| | | them to get an audio | | | | | server using |
| | | feedback. This device can | | | | | an |
| | | also he used to scan | | | | | intermediate |
| | | annotated books with | | | | | host such a PC |
| | | embedded | | | | | |
| 3 | Travelers | Label objects and record | Hand- | X | X | X | Only for |
| | Language | name of object in a foreign | written | | | | phone |
| | Learning | language | labels | | | | |
| | Tool. | | (numbering) | | | | |
| | (Type 1) | | or Barcode | | | | |
| 4 | Picture | Album cataloging, home | Hand- | X | X | X | Only for |
| | album | objects cataloging | written | | | | phone |
| | annotation | | labels | | | | |
| | (Type 1) | | (numbering) | | | | |
| | | | or Barcode | | | | |
| 5 | Class | When professor uses a | Hand- | X | X | X | Only for |
| | Lecture | printed book as the | written | | | | phone |
| | Annotation | reference for his lectures, | labels | | | | |
| | (Type 1) | his lecture can be spliced | (numbering) | | | | |
| | | bu the student and he can | or Barcode | | | | |
| | | correlate the page of the | | | | | |
| | | book with the appropriate | | | | | |
| | | annotation from the | | | | | |
| | | lecturer. | | | | | |
| 6 | Package | Useful for managing a | Handwritten | X | X | X | Only for |
| | Annotation, | move, a collectors fream | labels | | | | phone |
| | Cataloging | for cataloging possessions. | (numbering) | | | | |
| | Private | | or Barcode | | | | |
| | Collectibles | | | | | | |
| | (DVD, CD, | | | | | | |
| | books, etc) | | | | | | |
| | (Type 1) | | | | | | |
| 7 | Shopping | Record and playback | Barcode, | X | X | X | Only for |
| | List | grocery shopping list or | Handwritten | | | | phone |
| | (Type 1) | other to-do list | labels | | | | |
| 8 | Antique | Seller labels objects, | Handwritten | X | X | X | Only for |
| | Shows, | authors content, buyer plays | labels | | | | phone |
| | Auctions, | back content | (numbering) | | | | |
| | Art | | or Barcode | | | | |
| | Galleries | car showroom - label parts | | | | | |
| | (Type 1) | of car to explain features of | | | | | |
| | | the product | | | | | |
| 9 | City, | Multimedia Tours of cities | Barcode | | X | X | For Phone, |
| | Museum | and museums | and/or RFID | | | | For device |
| | Tours, Art | | label, | | | | with network |
| | Galleries | | Coordinates, | | | | connectivity |
| | (Types 1, 2, | | Timestamp, | | | | |
| | 3, and 4) | | linear | | | | |
| | | | ordering | | | | |

Examples of applications are shown in Table 2, applications 1-9. For example, the system and method can be used for cataloging the early words of a child (Table 2, application 1). All parents can fondly recall at least one memory of their child's first utterance of a particular word/sentence. They are also painfully aware that it is so hard to capture those invaluable moments when the child makes those precious first utterances of a word/sentence (by the time parent runs off to fetch an audio/video recorder, the child's attention has shifted to something new and it is virtually impossible to get the child to say it again). Also the charm of capturing the first utterance is never the same as the subsequent utterance of the same word/sentence.

To solve these problems, the apparatus described herein can be used to create a tour with a voice-activated recorder which records audio and catalogs it using a timestamp as the index. The system can be used to aggregate words/sentences spoken separately for each day thus serving as a chronicle of the child's learning process. The system can also be used to permit annotations of the authored content, the authored content being the child's voice. For example, a parent can annotate a particular word/sentence utterance of a child with the context in which it was uttered making the tour an invaluable chronicle of the child's language learning process.

The system can also be used to allow the parent to author multiple separate sentences in the parents own voice. This sentence would be randomly chosen and played when the child speaks to thereby encourage the child to speak more. The authored tour and the annotation can be retrieved from the device for safe-keeping and for sharing with others by uploading to a remote server. Uploaded content may be made accessible as public or private tours accessible by a cellular phone or PDA with wireless network connectivity. Though digital voice recorders of different flavors abound in the market, none of them match the key capabilities of the present invention which makes it best suited for this application. In particular, these devices do not support annotations of already recorded content nor authoring by a parent which is subsequently played as responses to the child speech which can serve to encourage the child to speak more.

The above-described functionality of the system can be integrated into child monitoring devices existing in the market today, such as the “First Years” brand child monitor. Specifically the capability of this embodiment may be integrated into the transmitter component of the device. It will be appreciated that the receiver is not an ideal place for integration since it receives other ambient RF signals in addition to the signals transmitted by the transmitter.

In still another application, the system and method can be used as a child's learning toy (Table 2, application 2). Preferably, in this application, a child-shield that selectively masks certain apparatus controls can be placed on the personal mobile device. The “toy usage” of the apparatus highlights ease of content authoring and playback. In an example of this application, a mother labels objects in her home (or even labeling parts of a book) using barcode, RFID or any other label type that can be transduced by some analog to digital means, and records information in her own voice about those objects. The child then scans the label and listens to the audio message recorded by the mother. The mother could hide the label in objects around the house, making the child go in search of the labels, find them and listen to the mother's recording. It would thus serve the purpose of a treasure hunt.

Yet another usage of the system and method is as a foreign language learning tool for an adult (Table 2, application 3). When an object is scanned, the personal mobile device would play the name of that object in a particular language. Still further, the system and method can be used to implement a digital audio player where the indexing serves as a play list.

In its usage as a cataloging apparatus, the subject system and method can be used to catalog picture albums, books, boxes during a move to a new apartment, etc. (Table 2, applications 4, 6). The system can rely on a simple labeling scheme which could involve using labels that are already present on the objects of interest or affixing custom labels on the objects. . A user might label the pictures, etc. in any desired order with a unique number. Coincident with the labeling, or subsequent to the labeling process, the user may author content for a particular index and manually preserve the association between the index value of a picture, etc. and the authored content. Should the mobile personal device 105 include a barcode scanner, the barcode scanner can assist in maintaining the correspondence between the picture, etc. and the authored content by supporting coincident authoring of content with the label detection. In this implementation the labeling scheme would be done using any barcode-encoding scheme that can be recognized by the barcode reader. In this scenario the author of the tour and the playback of the tour might be the same person or different persons.

The mobile personal device 105 can also provide interface controls for providing digital text input, e.g., an ordinal position of content in a tour. It may have an optional display that displays the index of the current content selection. Interface controls can provide an accelerated navigation of displayed indices by a press-and-hold of index navigation buttons thus enabling the device to quickly reach a desired index. This is advantageous since the index value may be large making it cumbersome to select a large index in the absence of keyboard input. The mobile personal device 105 could also be adapted to remember the last accessed index when the device is powered down to increase the speed of access if the same tour is later continued. In further embodiments, the personal mobile device 105 can have a mode selector that allows read only playback of content. This avoids accidental overwrite of recorded content.

When the system and method is used as a “personal cataloger/language learning/audio player,” then the tour authoring and playback apparatus 105 need only be provided with object scanning capability as it is intended for sedentary usage and, therefore, need not support coordinate-based labeling. This personal mobile device 105 can be adapted to allow multiple tours to be authored and resident on the device at the same time.

The system and method can also serve as a memory apparatus, for example, assisting in the creation of a shopping list and tracking the objects purchased while shopping to thereby serve as an automated shopping checklist (Table 2, application 7). To this end, the system can maintain a master list of object identifiers with a brief description of these objects created in the authoring mode.

Table 2, applications 8 and 9 are examples of tours particularly targeted to cellular phones and handheld devices (PDA). The system can be used as a tour authoring and playback device that implements all forms of object labeling and indexing mentioned earlier, e.g., text strings, transduced analog to digital data, barcode, RFID, IR, location coordinate, and timestamp. All of the tours may include any multimedia content and are not limited to audio. One application of such a “tourist-guide” is a tourist landing at an airport and using the system to obtain information about locations, historical sites, and indoor objects, seamlessly transitioning between proactive and implicit label detection domains 205. Furthermore, from the foregoing, it will be appreciated that the described system and method bridges the world of object-based information retrieval and location-based information retrieval to thereby provide a seamless transition between these two application domains.

In particular, the described system provides, among others, the following advantages not found in prior systems:

(1) Using the Internet as an easily accessible vast information resource, off-the-shelf multi-media capable portable handheld devices and ubiquitous wireless networks, the present innovation provides an open, interactive guide system. The user is an active, interactive participant of the guided tour, a creator and supplier as much as he/she is a consumer. Applications are only limited by imagination—ranging from educational toy, museum tours, language learning tours etc. In all of these applications, the user, with the aid of the present invention, is able to personalize, annotate the tour with his/her own impressions, share feedback with other users, initiate an interaction or transaction with other humans or machines.

a. The individual label objects themselves or use the existing labels on objects around her.

b. The author of a tour and the user of a tour (supplier and consumer) might be the same person(s) or different person(s).

c. A “private tour” can be easily published to the Internet or to a local community, and made “public” for other people to use, contribute, exchange or sell.

d. The tour is no longer a closed, finished product,—it can be personalized, shared, co-authored by people who have never met in person

e. Users may use their personal portable handheld devices, instead of renting specialized proprietary devices from institutions, and download only the software and content from the internet or local area networks.

f. Users and service providers have access to authoring tools to author and publish multimedia content including streaming video and audio.

g. The system provides system and method, to author and publish a tour, but the system does not restrict the content of the tour.

(2) The system can be used both indoors and outdoors.

(3) Tour content can be authored in different media types. The tour presentation depends on the capabilities of the device (audio only, text only, hypertext, multimedia, streaming video and audio etc) and would do appropriate media transformations and filtering. A tour would work both with and without network access. The user can download the tour content before the tour, and store it on a portable handheld device, or access the tour content dynamically via a wireless network.

(4) The system takes advantage of both existing object tags (barcodes, RFID, Infrared tags) and specialized tags made for a specific tour.

(5) The benefit of the logical aggregation of related content into a tour is clearly apparent, not just in the multitude of commercial applications, but also in the multitude of personal usage scenarios, such as an audio annotated album, a chronological repository of a child's early utterances, or a tour containing a mothers' annotation of her old home and the articles she left behind bequeathed to her children. The tour serves, in these cases, as an invaluable time warp triggering recall of fond memories that enrich our lives. It also plays the important role of immortalizing humans with a media rich snapshot of their lives.

Although the invention has been particularly shown and described with reference to several preferred embodiments thereof, it will be understood by those skilled in the art that various changes in form and details may be made therein without departing from the spirit and scope of the invention as defined in the appended claims.

I claim:

1. A method for authoring information relevant to a physical world, comprising:
detecting with an authoring device a first label associated with a first object; and
triggering, in response to detecting, a system for authoring content;
wherein the content is to be unambiguously bound to the first object and is to be rendered on a playback device during detection of the first label.

2. The method as recited in claim 1, wherein the system for authoring content is resident on the authoring device.

3. The method as recited in claim 1, wherein the authoring device and the playback device are integrated within a single apparatus.

4. The method as recited in claim 1, wherein the label is selected from a group consisting of a barcode label, a coordinate, a RFID tag, an IR tag, a time stamp, a text string, and any other label type whose information can be transformed to digital data by some transduction means.

5. The method as recited in claim 1, wherein the content is selected from a group consisting of audio, text, graphics, video, or a combination thereof.

6. The method as recited in claim 1, wherein the content is a link to a live agent.

7. The method as recited in claim 1, further comprising the steps of
detecting a second label associated with a second object;
triggering, in response to detecting, the system for authoring content which is unambiguously bound to the second object; and
aggregating the content bound to the first object and the second object into a single logical entity called a tour.

8. The method as recited in claim 1, further comprising the step of
detecting a second label associated with the first object and normalizing the first label and the second label such that the content bound to the first object can rendered during detection of either the first or second label in the playback mode.

9. The method as recited in claim 1, further comprising the step of storing the content in non-volatile memory resident in the apparatus.

10. The method as recited in claim 1, further comprising the step of uploading the content to a remote server.

11. The method as recited in claim 10, wherein the step of uploading is performed via a wireless network.

12. The method as recited in claim 10, wherein the step of uploading is performed via a wired network.

13. A computer-readable media having instructions for authoring information relevant to a physical world, the instructions performing steps comprising:
detecting a first label associated with a first object; and
triggering, in response to detecting, a system for authoring content to be unambiguously bound to the first object;
wherein the content is to be rendered during detection of the first label by a device in a playback mode.

14. The computer-readable media as recited in claim 13, wherein the instructions perform the further steps of
detecting a second label associated with a second object;
triggering, in response to detecting, a system for authoring content to be unambiguously bound to the second object; and
aggregating the content bound to the first object and the second object into a single logical entity called a tour.

15. The computer-readable media as recited in claim 14, wherein the instructions perform the further step of detecting a second label associated with the first object and normalizing the first label and the second label such that the content can rendered during detection of either the first or second label by the device in the playback mode.

16. A computer-readable media having instructions for authoring content to be associated with objects in a physical world, the instructions performing steps comprising:
normalizing a read object label associated with an object into an object identifier;
placing the object identifier into a index table repository;
accepting content to be rendered when the object label is read in a playback mode; and
binding the content to the object identifier in the index table repository.

17. The computer-readable media as recited in claim 16, wherein the instructions allow a plurality of different label types to be normalized to one object identifier.

18. A method for providing information relevant to a physical world, comprising:
detecting with a device a label associated with an object;
normalizing information contained in the detected label into an object identifier;
using the object identifier to search an index table repository to find content bound to the object identifier; and
rendering the content.

19. The method as recited in claim 18, further comprising the step of retrieving the content bound to the object identifier from local memory in the apparatus.

20. The method as recited in claim 18, further comprising the step of retrieving the content bound to the object identifier from a remote server.

21. The method as recited in claim 18, wherein the content is selected from a group consisting of audio, text, graphics, and video.

22. The method as recited in claim 18, wherein the label is selected from a group consisting of a barcode, a coordinate, an IR tag, a RFID tag, a timestamp, a text string, and any other label type whose information can be transformed to digital data by some transduction means.

23. The method as recited in claim 18, wherein the content is a connection to a live agent.

24. The method as recited in claim 18, further comprising the step of determining the current time and comparing the current time to the timestamp before rendering the content.

25. The method as recited in claim 18, wherein the step of rendering the content comprises streaming the content from a remote server.

26. The method as recited in claim 18, further comprising the steps of accepting annotations/feedback after the rendering of the content and binding the annotations/feedback to the object identifier.

27. The method as recited in claim 26, further comprising the step of storing the annotations/feedback in local memory.

28. The method as recited in claim 26, further comprising the step of storing the annotations/feedback in a remote memory.

29. A computer-readable media having instructions for providing information relevant to a physical world, the instructions performing steps comprising:
detecting a label associated with an object;
normalizing information contained in the detected label into an object identifier;
using the object identifier to search an index table repository to find content bound to the object identifier; and
rendering the content.

30. The computer-readable media as recited in claim 29, wherein the content is selected from a group consisting of audio, text, graphics, and video.

31. A method for providing information relevant to a physical world, comprising:
storing an object identifier indicative of a plurality of read labels associated with an object into an index table repository; and
using the index table repository to bind content to the object identifier and, accordingly, the object;
whereby the content is renderable when any one of the plurality of labels is detected in a playback mode.

32. The method as recited in claim 31, wherein at least one of the plurality of labels is already present on the object.

33. The method as recited in claim 31, further comprising the step of attaching at least one of the plurality of labels to the object.

34. The method as recited in claim 31, wherein the plurality of labels is selected from a group consisting of a barcode label, a coordinate, a RFID tag, an IR tag, a time stamp, a text string, or any other label type whose information that can be transformed to digital data by some transduction means.

35. The method as recited in claim 31, further comprising the steps of detecting the plurality of labels.

36. A method for providing information relevant to a physical world, comprising:
associating one or more labels with each of a plurality of objects in a tour;
storing an object identifier indicative or the one or more labels associated with each of the plurality of object in the tour in an index table repository;
authoring content relevant to each of the plurality of objects in the tour; and
binding the content to an object identifier in the index table repository which corresponds to the relevant one of the plurality of objects in the tour whereby the content is renderable when the label is detected by a playback device without regard to the order in which the content was authored.

37. The method as recited in claim 36, wherein the labels are selected from a group consisting of coordinates, barcode labels, RFID tags, IR tags, timestamps, text strings, and any label type whose information that can be transformed to digital data by some transduction means.

38. A system for authoring and retrieving selected digital multimedia information relevant to a physical world, comprising:
a plurality of machine readable labels relevant to the physical world;
an apparatus for detecting the machine readable labels and including programming for normalizing information contained in the detected label into an object identifier; and
a digital multimedia content collection accessible by the apparatus storing content indexed by the object identifiers.

39. The system as recited in claim 38, wherein the apparatus further comprises a system for authoring digital multimedia in response to detecting one of the plurality of labels which is to be stored within the digital multimedia content collection and unambiguously bound to the object identifier.

40. The system as recited in claim 39, wherein the apparatus further comprises a system for rendering digital multimedia in response to detecting one of the plurality of labels, the digital multimedia rendered being the content unambiguously bound to the object identifier associated with a detected label.

41. The system as recited in claim 40, wherein the digital multimedia content collection includes one or more of audio files, visual graphics files, text files, video files, XML files, hyperlink references, live agent connection links, programming code files, and configuration information files.

42. The system as recited in claim 40, wherein the apparatus comprises programming that renders digital multimedia as a function of output capabilities of the apparatus.

43. The system as recited in claim 3 8, wherein the tour is stored on one or more computer servers external to the apparatus.

44. The system as recited in claim 43, wherein the tour and the apparatus communicate via a wired network.

45. The system as recited in claim 43, wherein the tour and the apparatus communicate via a wireless network.

46. The system as recited in claim 45, wherein the wireless network comprises a cellular telephone network.

47. The system as recited in claim 38, wherein the tour resides on the apparatus.

48. The system as recited in claim 38, wherein the apparatus accesses the tour via the Internet.

49. The system as recited in claim 38, wherein the apparatus accesses the tour via a voice portal.

50. The system as recited in claim 38, wherein the apparatus accesses the tour via a cellular telephone voice mailbox.

51. The system as recited in claim 38, wherein the digital multimedia is aggregated into a tour.

52. The system as recited in claim 38, wherein the digital multimedia is randomly accessible by the apparatus.

53. The system as recited in claim 38, wherein the digital multimedia is accessible by the apparatus in a sequential order.

54. The system as recited in claim 38, wherein the apparatus comprises a personal digital assistant.

55. The system as recited in claim 38, wherein the apparatus comprises a cellular telephone.

56. The system as recited in claim 38, wherein the apparatus comprises purpose built devices targeted to a specific application.

57. An apparatus for authoring information relevant to a physical world, comprising:
circuitry for detecting a label associated with an object; and
a system for authoring content to be unambiguously bound to the object as represented by the detected label which content is to be rendered during detection of the label in a playback mode.

58. The apparatus as recited in claim 57, wherein the circuitry comprises a barcode reader.

59. The apparatus as recited in claim 57, wherein the circuitry comprises an IR tag reader.

60. The apparatus as recited in claim 57, wherein the circuitry comprises a RFID tag reader.

61. The apparatus as recited in claim 57, wherein the circuitry comprises a keyboard for inputting textual information.

62. The apparatus as recited in claim 57, wherein the circuitry comprises of analog to digital information transducer.

63. An apparatus for authoring and providing information relevant to a physical world, comprising:
circuitry for detecting a label associated with an object; and
programming for normalizing information contained in the detected label into an object identifier;
a system for authoring content in an authoring mode which content is to be unambiguously bound to the object identifier; and
a system for rendering content in a playback mode, the content rendered being the content unambiguously bound to the object identifier associated with a detected label.

64. The apparatus as recited in claim 63, further comprising a communications link for downloading authored content to a remote location and for retrieving content from the remote location for rendering.

65. The apparatus as recited in claim 63, further comprising a memory for storing the content.

66. The apparatus as recited in claim 63, wherein the circuitry comprises a barcode reader.

67. The apparatus as recited in claim 63, wherein the circuitry comprises an IR tag reader.

68. The apparatus as recited in claim 63, wherein the circuitry determines a coordinate location.

69. The apparatus as recited in claim 63, wherein the circuitry is a RFID tag reader.

70. The apparatus as recited in claim 63, wherein the circuitry i s an analog to digital information transducer.
